(19) United States
(12) Patent Application Publication
(10) Pub. No.: US 2016/0056545 A1
(43) Pub. Date: Feb. 25, 2016

(54) ANTENNA INCLUDING COUPLING STRUCTURE AND ELECTRONIC DEVICE INCLUDING THE SAME

(71) Applicant: Samsung Electronics Co., Ltd., Suwon-si (KR)

(72) Inventors: Sung Koo PARK, Suwon-si (KR); Soon Ho HWANG, Seoul (KR); Joon Ho BYUN, Yongin-si (KR); Chan Kyu AN, Incheon (KR); Jun Hwa OH, Seoul (KR)

(21) Appl. No.: 14/833,307

(22) Filed: Aug. 24, 2015

(30) Foreign Application Priority Data
Aug. 25, 2014 (KR) 10-2014-0111074

(51) Int. Cl. H01Q 21/30; H01Q 1/24; H01Q 1/48

(52) U.S. Cl. CPC H01Q 21/30; H01Q 1/48; H01Q 1/243

(57) ABSTRACT

An antenna for transmitting and receiving a multi-band signal is provided. The antenna includes a feeding unit, a first radiator connected to the feeding unit, a second radiator coupled with the first radiator, such that the first radiator and the second radiator are spaced apart from each other by a specific distance, and a ground unit connected to the second radiator.

### CROSS-REFERENCE TO RELATED APPLICATION(S)

This application claims the benefit under 35 U.S.C. §119(a) of a Korean patent application filed on Aug. 25, 2014 in the Korean Intellectual Property Office and assigned Serial number 10-2014-0111074, the entire disclosure of which is hereby incorporated by reference.

### TECHNICAL FIELD

The present disclosure relates to an antenna operating according to a coupling structure and an electronic device including the same.

### BACKGROUND

In general, an electronic device has a function for communication to perform communication with an external device. The electronic device includes an antenna for transmitting and receiving signals of various frequency bands. Since the number of frequency bands used in a wireless communication device and a required frequency bandwidth are increasing with the advancement of wireless communication technologies, the number of antennas mounted on the electronic device increases to cope with various frequencies.

A plurality of antennas for transmitting and receiving signals of various frequency bands of the related art (e.g., long term evolution (LTE), global positioning system (GPS), Bluetooth (BT)/Wi-Fi, and the like) may be mounted within a restricted antenna mounting space of an electronic device, thereby lowering the performance of the antenna.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an antenna and an electronic device including the same, capable of transmitting and receiving a multi-band frequency using a coupling structure.

In accordance with an aspect of the present disclosure, an antenna for transmitting and receiving a multi-band signal is provided. The antenna includes a feeding unit, a first radiator connected to the feeding unit, a second radiator coupled with the first radiator, such that the first radiator and the second radiator are spaced apart from each other by a specific distance, and a ground unit connected to the second radiator.

In accordance with another aspect of the present disclosure, an antenna for transmitting and receiving a multi-band signal is provided. The antenna includes a feeding unit, a first radiator connected to the feeding unit, a second radiator coupled with the first radiator, a first ground unit connected to one end of the second radiator, and a second ground unit connected to another end of the second radiator, wherein the second radiator comprises a segmentation portion having first and second ends spaced apart by a specific distance, and wherein a coupling is formed between the first and second ends of the segmentation portion.

An electronic device for transmitting and receiving a multi-band signal is provided. The electronic device includes a first antenna including a first segmentation portion implemented at a radiator, the first segmentation portion having first and second ends spaced apart by a first specific distance and a coupling formed between the first and second ends of the first segmentation portion, a second antenna including a second segmentation portion implemented at another radiator, the second segmentation portion having third and fourth ends spaced apart by a second specific distance and a coupling formed between the third and fourth ends of the second segmentation portion, and a common ground unit disposed between the first antenna and the second antenna.

An electronic device including an antenna configured to transmit and receive a multi-band signal is provided. Further, the antenna includes a feeding unit, a first radiator connected to the feeding unit, a second radiator coupled with the first radiator, such that the first radiator and the second radiator are spaced apart from each other by a specific distance, a ground unit connected to the second radiator, and an additional ground unit connected to the second radiator though switching.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram schematically illustrating a conceptual structure of an antenna according to an embodiment of the present disclosure;

FIG. 2A is a diagram schematically illustrating a conceptual structure of an antenna including a coupling structure and an additional ground unit according to an embodiment of the present disclosure;

FIG. 2B is a diagram schematically illustrating an implementation of an antenna including a coupling structure and an additional ground unit according to an embodiment of the present disclosure;

FIG. 3 is an input reflection coefficient graph schematically illustrating a shift of a resonant frequency due to turn-on/turn-off of a switching unit according to an embodiment of the present disclosure;

FIG. 4A is a diagram schematically illustrating an implementation of an antenna including a plurality of additional ground units according to an embodiment of the present disclosure;

FIG. 4B is a diagram schematically illustrating a circuit for controlling a switching unit according to an embodiment of the present disclosure;

FIGS. 5A and 5B are input reflection coefficient graphs schematically illustrating a shift of a resonant frequency due to turn-on/turn-off of a switching unit according to various embodiments of the present disclosure;

FIG. 6 is a diagram schematically illustrating a variety of conceptual structures of an antenna including a coupling structure according to an embodiment of the present disclosure;

FIGS. 7A and 7B are diagrams schematically illustrating antennas having a changed coupling structure according to various embodiments of the present disclosure;

FIGS. 8A and 8B are diagrams schematically illustrating an antenna in which a coupling structure is implemented at a second radiator according to various embodiments of the present disclosure;

FIG. 9A is a diagram schematically illustrating a conceptual structure of an antenna in which a plurality of coupling structures are implemented at a second radiator according to an embodiment of the present disclosure;

FIG. 9B is a diagram schematically illustrating an implementation of an antenna in which a plurality of coupling structures are implemented at a second radiator according to an embodiment of the present disclosure;

FIG. 9C is an input reflection coefficient graph of an antenna in which a plurality of coupling structures are implemented at a second radiator according to an embodiment of the present disclosure;

FIG. 10A is a diagram schematically illustrating a communication module including an antenna according to an embodiment of the present disclosure;

FIG. 10B is a communication efficiency graph of an antenna including a coupling structure according to an embodiment of the present disclosure; and

FIG. 11 is a block diagram illustrating an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “include,” “comprise,” “including,” and/or “comprising” used herein indicate disclosed functions, operations, or existence of elements but do not exclude other functions, operations or elements. It should be further understood that the terms “include,” “comprise,” “have,” “including,” “comprising,” and/or “having” used herein specify the presence of stated features, integers, operations, elements, components, and/or combinations thereof but do not preclude the presence or addition of one or more other features, integers, operations, elements, components, and/or combinations thereof.

The meaning of the term “or” used herein includes any combination of words listed together with the term. For example, the expression “A or B” may indicate A, B, or both A and B.

The terms, such as “first,” “second,” and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

In the description below, when one part (or element, device, etc.) is referred to as being “connected” to another part (or element, device, etc.), it should be understood that the former can be “directly connected” to the latter, or “electrically connected” to the latter via an intervening part (or element, device, etc.). It will be further understood that when one component is referred to as being “directly connected” or “directly linked” to another component, it means that no intervening component is present.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure.

Electronic devices according to various embodiments of the present disclosure may include an electronic device having a communication function. For example, the electronic devices may include at least one of smartphones, tablet personal computers (PCs), mobile phones, video telephones, electronic book readers, desktop PCs, laptop PCs, netbook computers, personal digital assistants (PDAs), portable multimedia players (PMPs), motion picture experts group (MPEG-1 or MPEG-2) audio layer 3 (MP3) players, mobile medical devices, cameras, wearable devices (e.g., head-mounted-devices (HMDs), such as electronic glasses), electronic apparel, electronic bracelets, electronic necklaces, electronic appcessories, electronic tattoos, smart watches, and the like.

According to various embodiments of the present disclosure, the electronic devices may be smart home appliances including a communication function. The smart home appliances may include at least one of, for example, televisions (TVs), digital versatile disc (DVD) players, audio players, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, electronic picture frames, and the like.

According to various embodiments of the present disclosure, the electronic devices may include at least one of the following devices including a communication function: medical devices (e.g., a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), and points of sales (POSs).

According to various embodiments of the present disclosure, the electronic devices may include at least one of the following devices including a communication function: parts of furniture or buildings/structures, electronic boards, electronic signature receiving devices, projectors, and measuring instruments (e.g., water meters, electricity meters, gas meters, and wave meters) including metal cases. The electronic devices according to various embodiments of the present disclosure may be one or more combinations of the above-mentioned devices. Furthermore, the electronic devices according to various embodiments of the present disclosure may be flexible devices. It would be obvious to those skilled in the art that the electronic devices according to various embodiments of the present disclosure are not limited to the above-mentioned devices.

Hereinafter, a coupling antenna technique according to various embodiments of the present disclosure will be described with reference to the accompanying drawings. The term “user” used herein may refer to a person who uses an electronic device or may refer to a device (e.g., an artificial electronic device) that uses an electronic device.

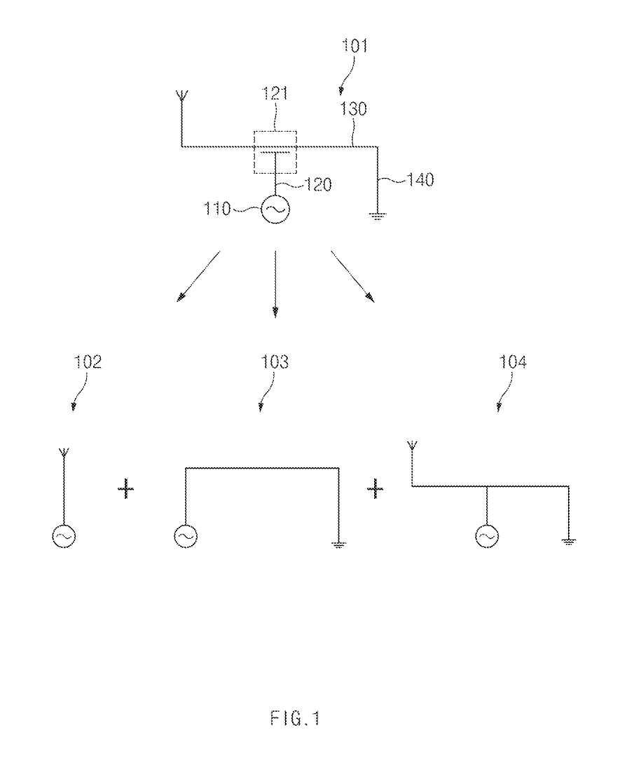

FIGS. 1 through 11, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a diagram schematically illustrating a conceptual structure of an antenna according to an embodiment of the present disclosure.

Referring to FIG. 1, an antenna 101 is illustrated, where the antenna 101 may include a feeding unit 110, a first radiator 120, a second radiator 130, and a ground unit 140.

The feeding unit 110 may be connected to the first radiator 120 and may feed the antenna 101 through the first radiator 120.

The first radiator 120 may be connected between the feeding unit 110 and the second radiator 130. The first radiator 120 may be directly connected with the feeding unit 110 and may be indirectly connected with the second radiator 130 through a coupling structure 121.

In the coupling structure 121, the first radiator 120 may be electrically connected with the second radiator 130, with the first and second radiators 120 and 130 spaced apart from each other. The coupling structure 121 may supply power from the first radiator 120 in a direction of the second radiator 130 through generation of a progressive wave. According to various embodiments of the present disclosure, the coupling structure 121 may include dielectric of which the permittivity is greater than “1.” A characteristic of the progressive wave transmitted through the coupling structure 121 may vary according to the permittivity of the dielectric.

According to various embodiments of the present disclosure, the first radiator 120 and the second radiator 130 may be coupled at a state where they face each other by the area greater than or equal to a specific size. In this case, the coupling structure 121 may be implemented such that a part of the first radiator 120 forms a first surface and a part of the second radiator 130 forms a second surface facing the first surface. The areas of the first and second surfaces may be differently determined according to a communication environment, a design environment, or the like.

In a case where the first radiator 120 is directly connected to the second radiator 130, the antenna 101 may operate as a single-type antenna (e.g., inverted-F antenna (IFA)). However, in a case where the first radiator 120 has the coupling structure 121 illustrated in FIG. 1, the antenna 101 may operate as a multi-mode antenna such as a monopole type antenna 102, a loop type antenna 103, or an IFA 104.

The second radiator 130 may be connected with the first radiator 120 through the coupling structure 121. According to various embodiments of the present disclosure, a part of the second radiator 130 may constitute the coupling structure 121 together with the first radiator 120 spaced apart therefrom by a specific distance. According to various embodiments of the present disclosure, the second radiator 130 may be implemented with a metal structure which is formed outside an electronic device.

The ground unit 130 may be connected to the second radiator 130. An electrical length of the second radiator 130 may be determined according to a location where the ground unit 140 is connected with the second radiator 130, and a resonant frequency may shift according to the electrical length of the second radiator 130.

The antenna 101 may operate as the monopole type antenna 102, the loop type antenna 103, or the IFA 104, based on a resonance manner of the coupling structure 121. The antennas 102 to 104 may be exemplifications associated with operation modes of the antenna 101, not limited thereto. The antenna 101 may operate as various types of antennas based on shapes or locations of the first radiator 120, the second radiator 130, and the ground unit 140, a connection location of the coupling structure 121, or the like.

The monopole type antenna 102 may correspond to a case that the antenna 101 is driven through the feeding unit 110 and the first radiator 120. In this case, the antenna 101 may resonate at λ/4(λ: wavelength).

The loop type antenna 103 may correspond to a case that the antenna 101 is driven through the feeding unit 110, the first radiator 120, and a right part of the second radiator 130. In this case, the antenna 101 may resonate at λ/2(λ: wavelength).

The IFA 104 may correspond to a case that the antenna 101 is driven through the feeding unit 110, the first radiator 120, the second radiator 130, and the ground unit 140. In this case, the antenna 101 may resonate at λ/4 (λ: wavelength).

The antenna 101 may operate in various modes using the coupling structure 121 and may transmit and receive a multi-band frequency signal. The antenna 101 may be implemented to transmit and receive signals of various signal bands (e.g., long term evolution (LTE) communications (Main, Sub1, and Sub2), Wi-Fi/Bluetooth (BT), and GPS signal bands) within a restricted antenna mounting space of an electronic device such as a smart phone or a tablet.

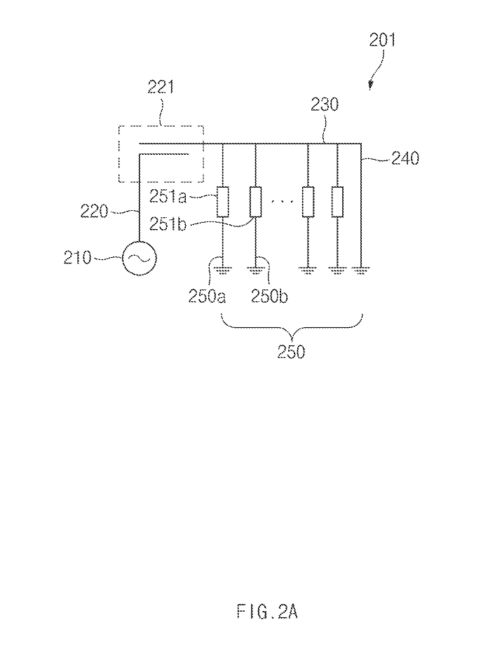

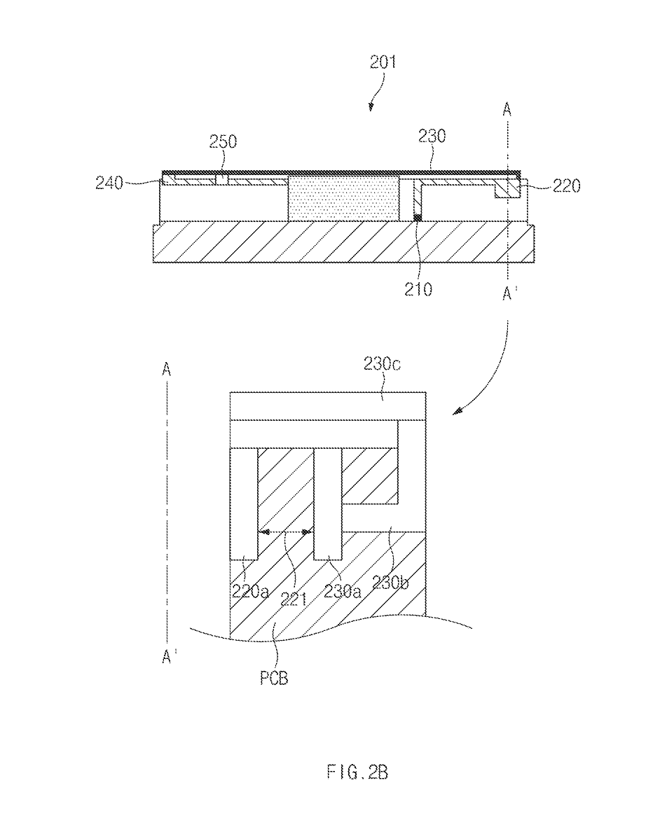

FIG. 2A is a diagram schematically illustrating a conceptual structure of an antenna including a coupling structure and an additional ground unit according to an embodiment of the present disclosure.

Referring to FIG. 2A, an antenna 201 is illustrated, where the antenna 201 may include a feeding unit 210, a first radiator 220, a second radiator 230, a ground unit 240, and an additional ground unit 250 including ground unit 250a and 250b. Functions or operations of the feeding unit 210, the first radiator 220, the second radiator 230, and the ground unit 240 may be the same as or similar to those of the antenna 101 of FIG. 1.

The additional ground unit 250 may be connected to the second radiator 230. The additional ground unit 250 may be disposed such that it is closer to a coupling structure 221 than the ground unit 240. The additional ground unit 250 may be connected to or separated from the second radiator 230 based on an operation (turn-on/turn-off) of switching units 251a and 251b, thereby making it possible to adjust an electrical length of the second radiator 230. For example, when the additional ground unit 250 is electrically connected to the second radiator 230 through a switching unit 251a or 251b that is turned on, an electrical length of the second radiator 230 may be shorter than that when the switching unit 251a or 251b is turned off, and a resonant frequency may become shorter. In a case where the switching unit 251a or 251b is turned off, an electrical length of the second radiator 230 may extend up to a portion where the ground unit 240 is connected thereto, and a resonant frequency may become lower.

According to various embodiments of the present disclosure, the additional ground unit 250 may be implemented with a plurality of ground units. Each of the plurality of ground units may be connected to the second radiator 230 through switching. The plurality of ground units may be selectively connected to the second radiator 230 through a control signal, and an electrical length of the second radiator 230 may be varied according to a location of the connected ground unit. In a case where an electrical length of the second radiator 230 is varied according to switching, a resonant frequency of the antenna 201 may be also varied. For example, in a case where the switching unit 251 a is turned on with only the switching unit 25 lb turned on, an electrical length of the second radiator 230 may become shorter and a resonant frequency may become higher.

FIG. 2B is a diagram schematically illustrating an implementation of an antenna including a coupling structure and an additional ground unit according to an embodiment of the present disclosure.

Referring to FIG. 2B, an antenna 201 is illustrated, where the antenna 201 is disposed at a top end portion or a bottom end portion of an electronic device. However, the scope and spirit of the present disclosure may not be limited thereto.

Referring to FIG. 2B, an antenna 201 may include a feeding unit 210, a first radiator 220, a second radiator 230, a ground unit 240, and an additional ground unit 250. For example, the antenna 201 may be an LTE main antenna.

The first radiator 220 may be implemented on a printed circuit board (PCB). A first end of the first radiator 220 may be connected to the feeding unit 210, and a second end thereof may constitute a coupling structure 221 together with the second radiator 230 (e.g., an external metal structure of an electronic device). The second end may form a surface facing a part of the second radiator 230. According to various embodiments of the present disclosure, the first radiator 220 may resonate at λ/4 (λ: wavelength).

According to various embodiments of the present disclosure, the first radiator 220 may be disposed at the outermost surface of the PCB. The first radiator 220 may be patterned in the form of PCB embedded antenna (PEA).

The second radiator 230 (e.g., an external metal structure of an electronic device) may be indirectly connected with the first radiator 210 through the coupling structure 221. According to various embodiments of the present disclosure, a part of the second radiator 230 may be formed within the PCB and may be connected with the outermost layer of the PCB through a via. The part of the second radiator 230 may form a surface facing the first radiator 220. Additional information associated with the coupling structure 221 may be provided through a cross-sectional view taken along a line A-A′.

The ground unit 240 may be connected to the second radiator 230 through a contact structure. The ground unit 240 may be continuously connected to the second radiator 230 without a switching circuit.

The additional ground unit 250 may be connected to the second radiator 230 through the switching unit. The additional ground unit 250 may be disposed such that it is closer to the coupling structure 221 than the ground unit 240. The switching unit may be patterned in the form of PEA. According to various embodiments of the present disclosure, a sum of a PEA patterning length of the switching unit and the whole length of the second radiator 230 may allow an antenna to resonate at λ/4 (λ: wavelength).

According to various embodiments of the present disclosure, the additional ground unit 250 may be switched through an active element. The active element may include a tunable IC, a switch IC, diode, and the like.

According to various embodiments of the present disclosure, the additional ground unit 250 may be implemented with a plurality of ground units. The plurality of ground units may be selectively connected to the second radiator 230 through a control signal. An electrical length of the second radiator 230 may be varied according to a location of the additional ground unit 250 connected through switching, and a resonant frequency may be also varied according to a variation in the electrical length.

Referring to a cross-sectional view taken along a line A-A′, a part 220a of the first radiator 220 may constitute the coupling structure 221 together with the part 230a of the second radiator 230. The part 220a of the first radiator 220 may form a surface facing the part 230a of the second radiator 230. The part 220a of the first radiator 220 may be formed at the outermost surface of the PCB. The part 230a of the second radiator 230 may be formed within the PCB and may be connected to the outermost layer of the PCB through a connection unit 230b (e.g., a via hole). The connection unit 230b may be connected with a metal structure 230c through a c_clip or contact structure at the outermost layer of the PCB.

Dielectric included in a coupling structure may be formed of a part of the PCB. However, the scope and spirit of the present disclosure may not be limited thereto. For example, the dielectric may be formed of any other material based on a design environment or a manufacturing environment.

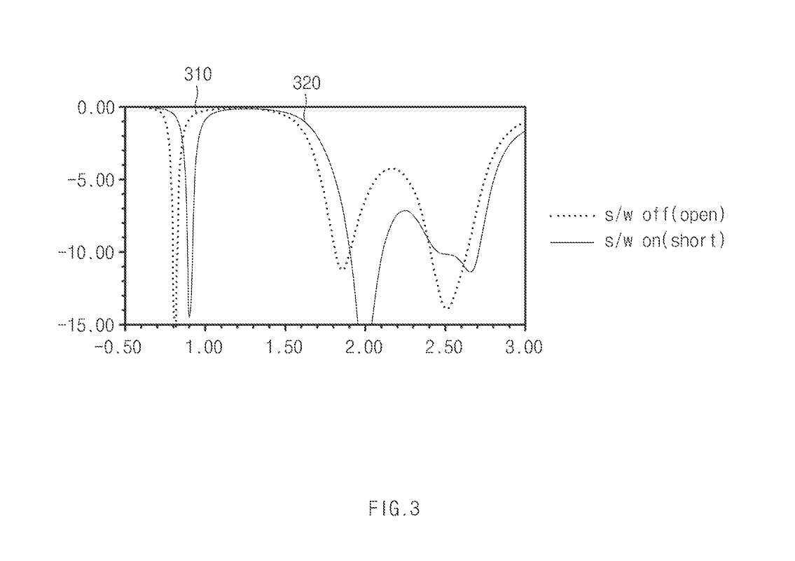

FIG. 3 is an input reflection coefficient graph schematically illustrating a shift of a resonant frequency due to turn-on/turn-off of a switching unit according to an embodiment of the present disclosure.

Referring to FIGS. 2A, 2B, and 3, the antenna 201 may include the feeding unit 210, the first radiator 220, the second radiator 230, the ground unit 240, and the additional ground unit 250. The additional ground unit 250 may be disposed such that it is closer to the coupling structure 221 than the ground unit 240. A resonant frequency of the antenna 201 may be varied according to turn-on/turn-off of the switching unit 251 included in the additional ground unit 250.

In a case where the switching unit 251a or 251b is turned off by a control signal (graph 310), the antenna 201 may not be affected by the additional ground unit 250. In this case, the second radiator 230 may be connected to the ground unit 240, thereby making it possible to transmit and receive a signal of a specific resonant frequency (e.g., 800 GHz).

In a case where the switching unit 251a or 251b is turned on by the control signal (graph 320), the antenna 201 may be affected by the additional ground unit 250. In this case, an electrical length of the second radiator 230 may become shorter, and a resonant frequency (e.g., 900 GHz) may become higher.

In a case where the switching unit 251a or 251b is turned on such that the additional ground unit 250 is disposed to be adjacent to the coupling structure 221, the electrical length of the second radiator 230 may become shorter. A connection point of the second radiator 230 where the additional ground unit 250 is connected may be changed according to a communication environment or a design environment. For example, as illustrated in FIG. 3, a connection point of the additional ground unit 250 may be set such that a resonant frequency is shifted according to turn-on/turn-off of the switching unit 251a or 251b by 100 MHz.

According to various embodiments of the present disclosure, the additional ground unit 250 may be implemented with a plurality of ground units. The plurality of ground units may be selectively connected to the second radiator 230 through a control signal. For example, if one of the plurality of ground units is selected through the switching unit 251 at a state where a fundamental resonant frequency is set to a 700-MHz band by adjusting a length of the second radiator 230, the resonant frequency may be shifted into frequency bands such as 800 MHz, 850 MHz, 900 MHz, and the like.

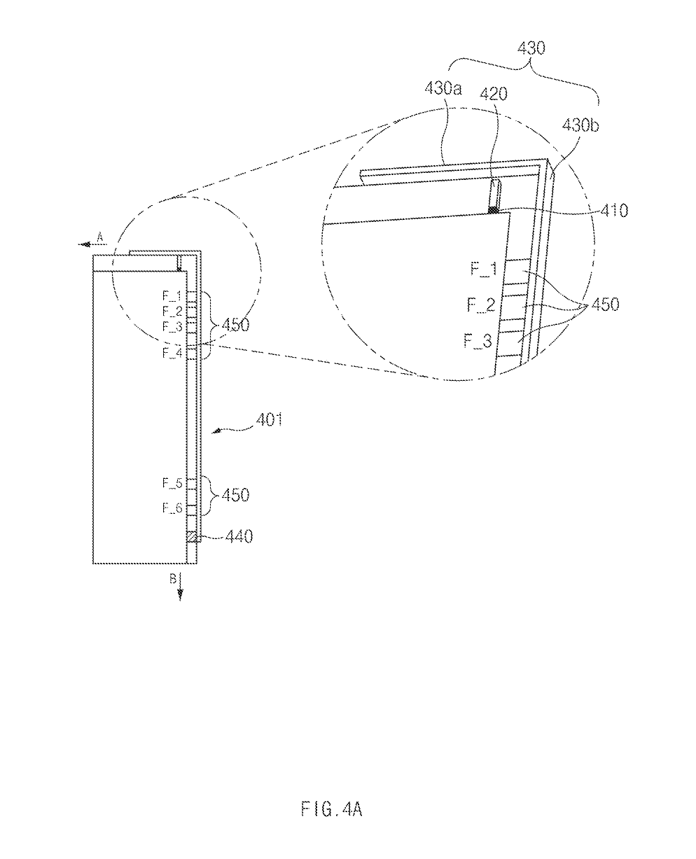

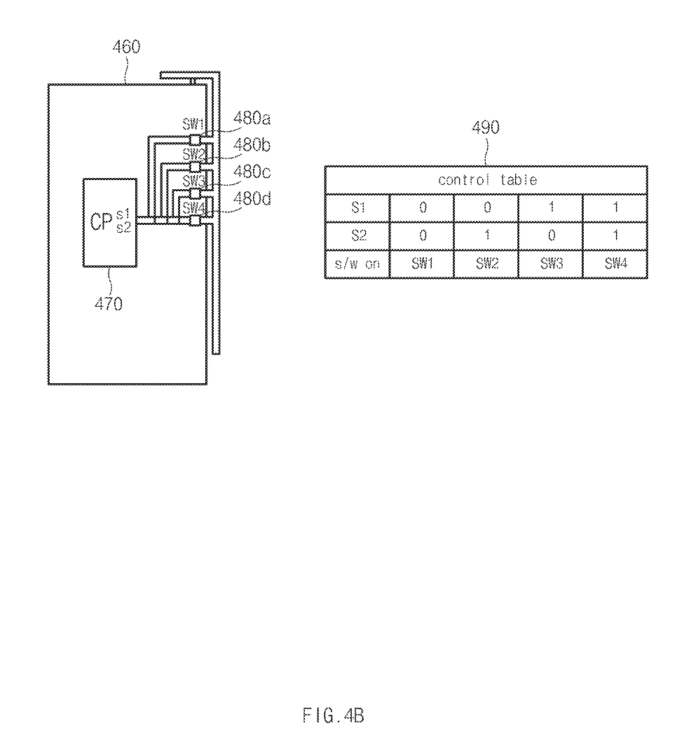

FIG. 4A is a diagram schematically illustrating an implementation of an antenna including a plurality of additional ground units according to an embodiment of the present disclosure.

Referring to FIG. 4A, an antenna 401 is illustrated, where the antenna 401 may include a feeding unit 410, a first radiator 420, a second radiator 430, a ground unit 440, and an additional ground unit 450. For example, the antenna 401 may be an LTE sub-antenna.

The feeding unit 410 may be connected to the first radiator 420 and may feed the antenna 401 through the first radiator 420.

The first radiator 420 may be implemented on a PCB. The first radiator 420 may be disposed at the outermost surface of the PCB. The first radiator 420 may be patterned in the form of PEA.

A first end of the first radiator 420 may be connected to the feeding unit 410, and a second end thereof may constitute a coupling structure together with the second radiator 430. The second end may form a surface facing the second radiator 430. According to various embodiments of the present disclosure, in a case where the first radiator 420 operates as an LTE sub-antenna of an electronic device, it may be set not to form resonance with a signal of a specific frequency band (e.g., 700 MHz to 3 GHz). In this case, the first radiator 420 may excite a signal to transmit it to the second radiator 430.

The second radiator 430 may be connected with the first radiator 420 through a coupling structure. According to various embodiments of the present disclosure, a part of the second radiator 430 may be formed within the PCB and may be connected with the outermost layer of the PCB. The second radiator 430 may include a metal structure (e.g., a side metal frame of an electronic device) connected through a c_clip or contact structure at the outermost layer of the PCB.

According to various embodiments of the present disclosure, the metal structure may be implemented in the form of bending (e.g., 90 degrees). For example, in a case where a metal structure 430 is partitioned into a first metal portion 430a and a second metal portion 430b by the bending, the first metal portion 430a may be formed in parallel with a bottom surface (or a top surface) of an electronic device in which the antenna 401 is mounted, and the second metal portion 430b may be formed in parallel with a side of the electronic device. According to various embodiments of the present disclosure, the first radiator 420 may be indirectly connected with the first metal portion 430a through a coupling structure. The ground unit 440 and the additional ground unit 450 may be connected to the second metal portion 430b. In this case, the metal structure may form a field at an end of the first metal portion 430a (direction A) and may form a field even at an end of the second metal portion 430b (direction B).

The additional ground unit 450 may be connected to the second radiator 430 through a switching unit (e.g., F_1 to F_6). According to various embodiments of the present disclosure, the additional ground unit 450 may be connected to the second metal portion 430b.

The additional ground unit 450 may be selectively connected to the second radiator 430 according to a control signal. An electrical length of the second radiator 430 may be varied according to a connection location of the additional ground unit 450. For example, an electrical length of the second radiator 430 when F_1 is turned on by the control signal may be shorter than that when F_6 is selected by the control signal, and a resonant frequency may become higher.

FIG. 4B is a diagram schematically illustrating a circuit for controlling a switching unit according to an embodiment of the present disclosure. A circuit for controlling four switching units (e.g., SW1 to SW4) may be exemplified in FIG. 4B. However, the scope and spirit of the present disclosure may not be limited thereto.

Referring to FIG. 4B, a control module 460 is illustrated, where the control module 460 may include a control unit 470 and first to fourth switching units 480a to 480d.

The control unit 470 may control the first to fourth switches 480a to 480d using control signals S1 or S2. A control table 490 may illustrates switching units which are selected according to values of the control signals S1 and S2. The control table 490 may not be limited thereto.

In a case where S1=0 and S2=0, the switching unit 480a may be turned on. In this case, a second radiator 430 may have the shortest electrical length, and a resonant frequency may be shifted into a high-frequency band. In a case where S1=1 and S2=1, the switching unit 480d may be turned on. In this case, the second radiator 430 may have the longest electrical length, and a resonant frequency may be shifted into a low-frequency band.

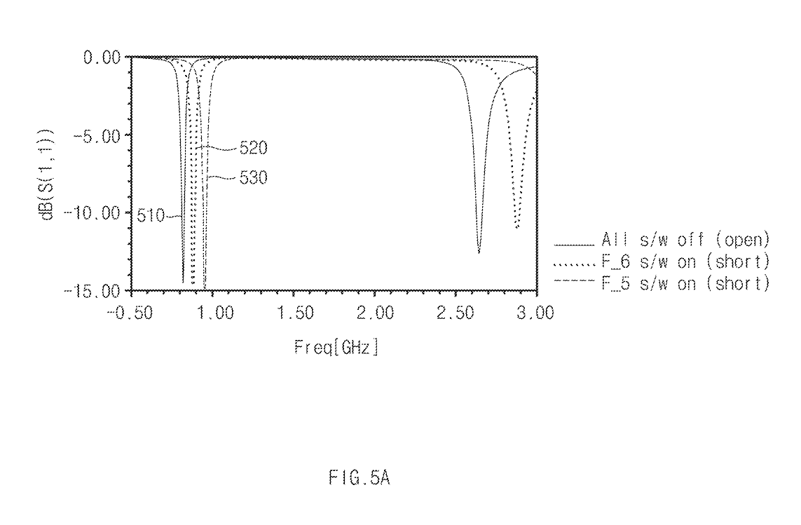

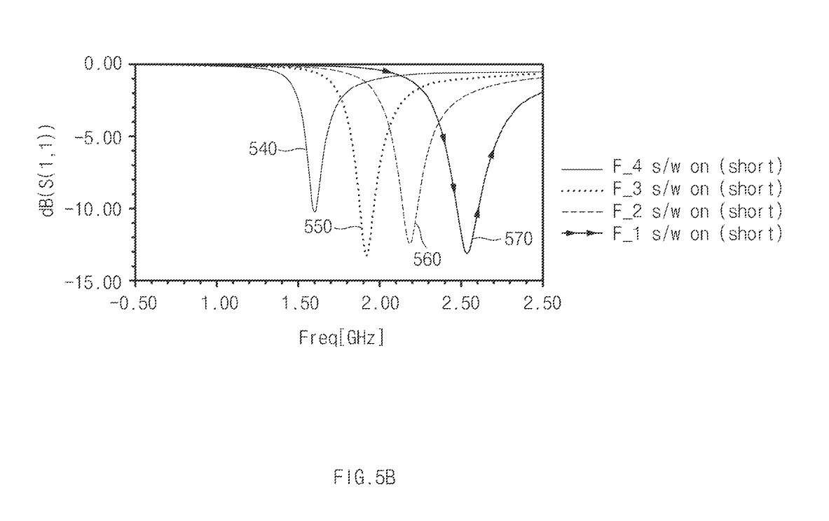

FIGS. 5A and 5B are input reflection coefficient graphs schematically illustrating a shift of a resonant frequency due to turn-on/turn-off of a switching unit according to various embodiments of the present disclosure.

Referring to FIGS. 4A and 5A, the antenna 401 may include the feeding unit 410, the first radiator 420, the second radiator 430, the ground unit 440, and the additional ground unit 450. The additional ground unit 450 may be disposed such that it is closer to a coupling structure than the ground unit 440. A resonant frequency of the antenna 401 may be varied according to turn-on or turn-off of a switching unit included in the additional ground unit 450. The additional ground unit 450 may be connected to the second radiator 430 through switching units (e.g., F_1 to F_6).

In a case where all switching units are turned off (graph 510 of FIG. 5A), the antenna 401 may not be affected by the additional ground unit 450. In this case, the antenna 401 may operate through the ground unit 440 and may transmit and receive a signal corresponding to a specific resonant frequency (e.g., 800 MHz).

In a case where the switching unit F_5 or F_6 disposed to be relatively closer to the ground unit 440 is turned on or turned off by a control signal (graph 520 or 530 of FIG. 5A), the antenna 401 may have a resonant frequency of a band adjacent to a resonant frequency which is generated when all switching units are turned off As the switching units F_6 and F_5 are sequentially turned on, an electrical length of the second radiator 430 may be gradually shortened, thereby making it possible to shift a resonant frequency into a frequency band (e.g., 900 MHz) higher than that (e.g., 800 MHz) when all switching units are turned off

Referring to FIGS. 4A and 5B, compared with a case where the switching unit F_5 or F_6 is controlled (FIG. 5A), the antenna 401 may transmit and receive a signal of a high-frequency band in a case where switching units F_1 to F_4 far away from the ground unit 440 are turned on or turned off by a control signal (graphs 540 to 570 of FIG. 5B).

As the switching units F_4 to F_1 are sequentially turned on, an electrical length of the second radiator 430 may be gradually shortened, and a resonant frequency may be gradually shifted into a high-frequency band (e.g., 1.5 GHz to 2.5 GHz).

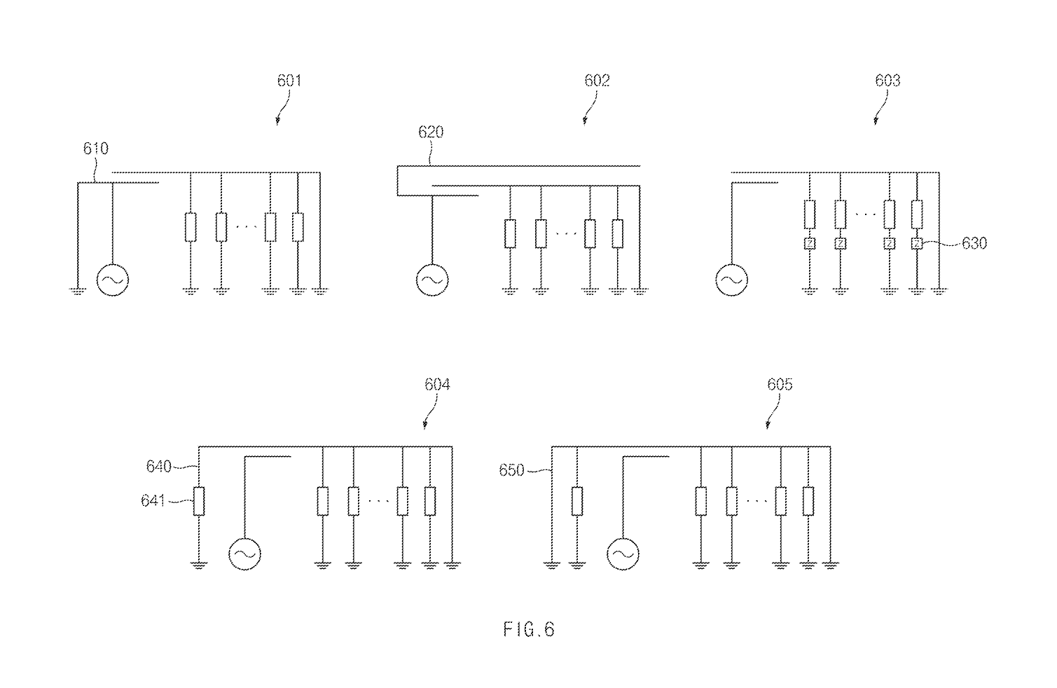

FIG. 6 is a diagram schematically illustrating a variety of conceptual structures of an antenna including a coupling structure according to an embodiment of the present disclosure.

Referring to FIG. 6, antennas 601 to 605 are illustrated, where the antennas 601 to 605 may be implemented by partially changing the antenna 201 of FIG. 2A so as to have various resonant frequencies. However, the scope and spirit of the present disclosure may not be limited thereto.

The antenna 601 may be implemented such that a ground unit 610 is additionally connected to the first radiator 220 of the antenna 201 of FIG. 2A. The ground unit 610 may change the whole impedance of the antenna 601 to vary a resonant frequency. A connection location (or a distance from a coupling structure) of the ground unit 610 may be adjusted according to a communication environment or a design environment.

The antenna 602 may be implemented such that an additional radiator 620 is connected to the first radiator 220 of the antenna 201 of FIG. 2A. The first radiator 220 of the antenna 201 illustrated in FIG. 2A may have a resonant frequency of λ/4 (λ: wavelength), and the first radiator and the additional radiator 620 of the antenna 602 may have a multi-band resonant frequency.

The antenna 603 may be implemented such that a lumped element 630 is additionally connected to each additional ground unit of the antenna 201 illustrated in FIG. 2A. A resonant frequency of the antenna 603 may be shifted by connecting a lumped element(s), such as an inductor, a capacitor, a resistor, and the like, to the additional ground unit. Various kinds of lumped elements may be connected according to a communication environment or a design environment.

The antenna 604 may be implemented such that an additional ground unit 640 is additionally connected to the second radiator 230 of the antenna 201 illustrated in FIG. 2A. The additional ground unit 640 may be disposed at a point, which faces a point where an additional ground unit or ground unit is disposed, with a coupling structure as the center. The additional ground unit 640 may include a switch 641, and the switch 641 may be turned on or turned off by a control signal. A resonant frequency of the antenna 604 may be varied according to turn-on/turn-off of the switch 641.

The antenna 605 may be implemented such that a ground unit 650 is additionally connected to the antenna 604. The ground unit 650 may be continuously connected to the second radiator 230 without separate switching. A resonant frequency of the antenna 605 may be varied according to a change in a connection location of the ground unit 650.

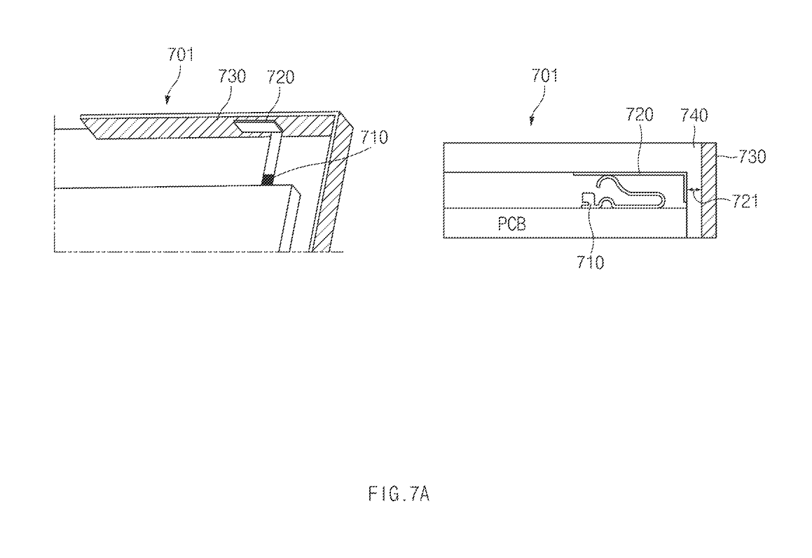

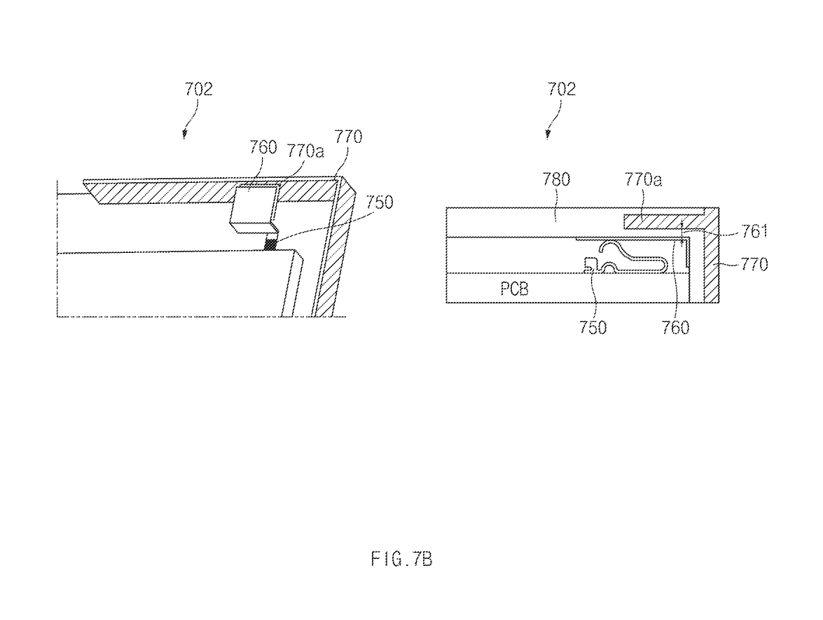

FIGS. 7A and 7B are diagrams schematically illustrating antennas having a changed coupling structure according to various embodiments of the present disclosure.

A coupling structure may be formed in various directions and may include various dielectric materials. A characteristic of a progressive wave transmitted through the coupling structure may be varied according to permittivity of the dielectric. According to various embodiments of the present disclosure, the dielectric may be implemented with a part of a PCB or an external cover (e.g., a battery cover and the like) and may have the permittivity which is greater than “1.”

Referring to FIG. 7A, an antenna 701 is illustrated, where the antenna 701 may include a feeding unit 710, a first radiator 720, a second radiator 730, and an external cover 740.

The feeding unit 710 may be connected to the first radiator 720 and may feed the antenna 701 through the first radiator 720.

The first radiator 720 may be connected between the feeding unit 710 and the second radiator 730. The first radiator 720 may be directly connected with the feeding unit 710 and may be connected with the second radiator 730 through a coupling structure 721. Coupling may occur on a surface of the first radiator 720 facing the second radiator 730 over a specific area.

The second radiator 730 may be connected with the first radiator 720 through the coupling structure 721. According to various embodiments of the present disclosure, the second radiator 730 may be a conductive material surrounding a circumference surface of an outer cover 740 of an electronic device that includes the antenna 701 or a conductive material forming an outer structure of the electronic device. For example, the second radiator 730 may be a metal frame structure.

The coupling structure 721 may be a structure in which the first radiator 720 is not directly connected to the second radiator 730 but is electrically connected thereto, with the first and second radiators 720 and 730 spaced apart from each other by a specific distance. The coupling structure 721 may generate a progressive wave to feed the second radiator 730. According to various embodiments of the present disclosure, the coupling structure 721 may include dielectric. A part of the outer cover 740 may be included within the coupling structure 721 and may act as the dielectric. The outer cover 740 may be formed of a material such as plastic and the like and may be formed of material of which the permittivity is greater than “1.”

Referring to FIG. 7B, an antenna 702 is illustrated, where the antenna 702 may include a feeding unit 750, a first radiator 760, a second radiator 770, and an outer cover 780.

The feeding unit 750 may be connected to the first radiator 760 and may feed the antenna 702 through the first radiator 760.

The first radiator 760 may be connected between the feeding unit 750 and the second radiator 770. The first radiator 760 may be directly connected with the feeding unit 750 and may be connected with the second radiator 770 through a coupling structure 761. Coupling may occur on a surface of the first radiator 770 facing the second radiator 770 over a specific area.

The second radiator 770 may be connected with the first radiator 760 through the coupling structure. The second radiator 770 may be an outer conduction structure forming a side portion of an electronic device which includes the antenna 702. For example, the second radiator 770 may be a metal frame structure. According to various embodiments of the present disclosure, a part 770a of the second radiator 770 may be recessed in the outer cover 780. The part 770a of the second radiator 770 may be formed to be surrounded by the outer cover 780. The part 770a of the second radiator 770 may constitute the coupling structure 761 together with the first radiator 760.

The coupling structure 761 may be a structure in which the first radiator 760 is not directly connected to the part 770a of the second radiator 770 but is electrically connected thereto, with the first radiator 760 and the part 770a spaced apart from each other by a specific distance. The coupling structure 761 may generate a progressive wave to feed the second radiator 770. The coupling structure 761 may include dielectric. A part of the outer cover 780 may be included within the coupling structure 761 and may act as the dielectric. A part of the outer cover 740 which is disposed between the first radiator 760 and the part 770a of the second radiator 770 may act as the dielectric.

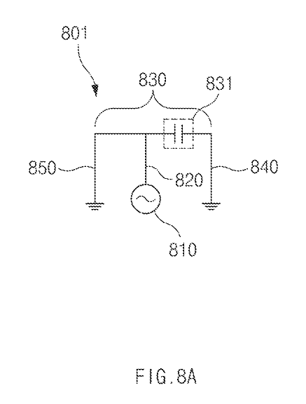

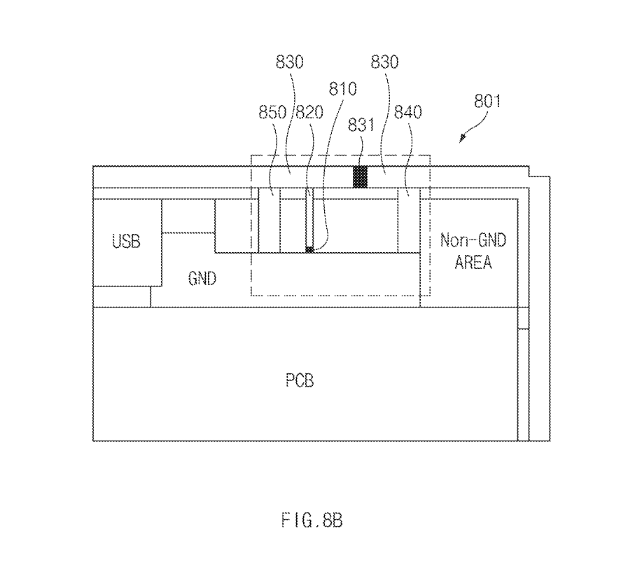

FIGS. 8A and 8B are diagrams schematically illustrating an antenna in which a coupling structure is implemented at a part of a second radiator according to an embodiment of the present disclosure.

Referring to FIG. 8A, an antenna 801 is illustrated, where the antenna 801 may have a resonance characteristic different from the antenna 101 illustrated in FIG. 1, because a coupling structure 831 is implemented at a second radiator 830.

FIG. 8A is a conceptual structure diagram of an antenna in which a coupling structure is implemented at a second radiator.

Referring to FIG. 8A, the antenna 801 may include a feeding unit 810, a first radiator 820, the second radiator 830, a first ground unit 840, and a second ground unit 850.

The feeding unit 810 may be connected to the first radiator 820 and may feed the antenna 801 through the first radiator 820.

The first radiator 820 may be connected between the feeding unit 810 and the second radiator 830. The first radiator 820 may be directly connected with the feeding unit 810 and may be directly connected with the second radiator 830.

The second radiator 830 may be directly connected with the first radiator 820. The second radiator 830 may include a metal structure as a radiator. At least a part of the second radiator 830 may be implemented with a coupling structure 831. According to various embodiments of the present disclosure, the second radiator 830 may be a conduction structure for the outside of an electronic device including PCB. For example, the second radiator 830 may be a metal frame structure.

The first ground unit 840 may be connected to a first end of the second radiator 830 which is adjacent to the coupling structure 831. The second ground unit 850 may be connected to a second end of the second radiator 830 which is opposite to the first end.

According to various embodiments of the present disclosure, a resonance characteristic may be varied according to a change in a position of the second radiator 830 where the coupling structure 831 is disposed. For example, a resonant frequency when the coupling structure 831 is disposed to be adjacent to the first radiator 820 may be different from that when the coupling structure 831 is disposed to be adjacent to the first ground unit 840.

FIG. 8B is a diagram schematically illustrating implementation of an antenna in which a coupling structure is implemented at a second radiator.

Referring to FIG. 8B, an antenna 801 is illustrated, where the antenna 801 may include a feeding unit 810, a first radiator 820, a second radiator 830, a first ground unit 840, and a second ground unit 850.

Unlike FIG. 1, the second radiator 830 may be directly connected with the first radiator 820. At least a part of the second radiator 830 may be used to implement a coupling structure 831. According to various embodiments of the present disclosure, the second radiator 830 may include a metal structure. The coupling structure 831 may be implemented at a segmented portion (hereinafter referred to as a “segmentation portion”) of the metal structure. Coupling may be generated between ends of the segmentation portion. The segmentation portion may include dielectric such as plastic and the like.

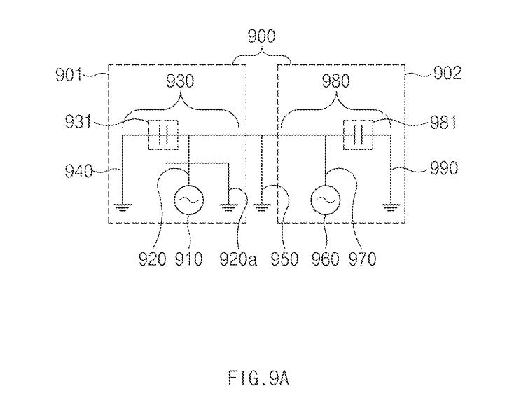

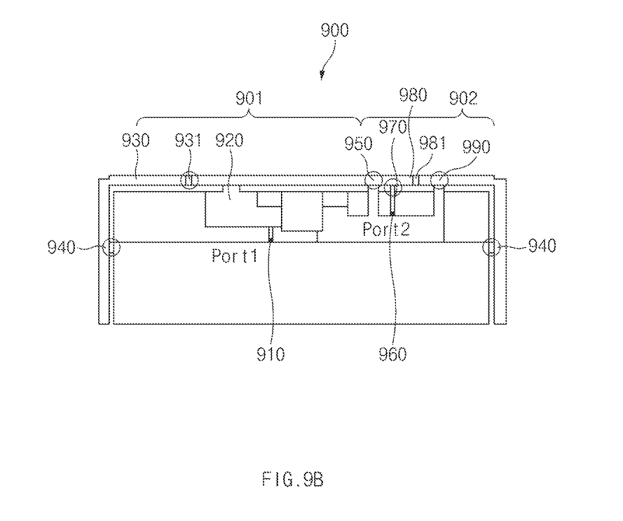

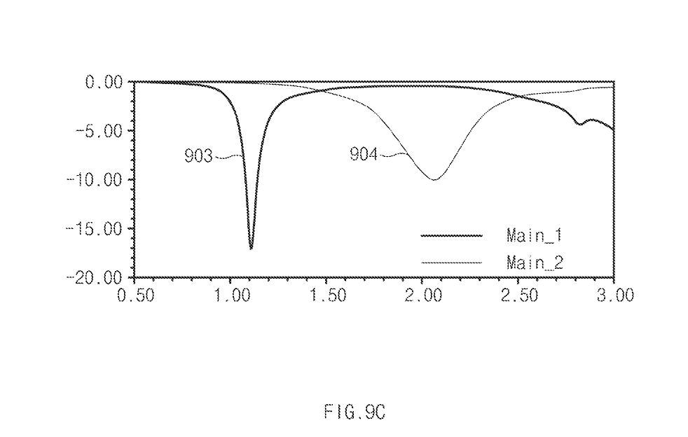

FIG. 9A is a diagram schematically illustrating a conceptual structure of an antenna in which a plurality of coupling structures are implemented at a second radiator according to an embodiment of the present disclosure.

Referring to FIG. 9A, an antenna 900 is illustrated, where the antenna 900 may include a first antenna 901, a second antenna 902, and a common ground unit 950.

The first antenna 901 may include a first feeding unit 910, a first radiator 920, a second radiator 930, and a ground unit 940.

The first radiator 920 may include an additional connection portion 920a. The additional connection portion 920a may be connected to the middle of the first radiator 920 and may vary a resonant frequency of the first antenna 901. According to various embodiments of the present disclosure, the additional connection portion 920a may include an additional radiator and an additional ground unit.

The second radiator 930 may be directly connected with the first radiator 920 and may include a coupling structure 931. According to various embodiments of the present disclosure, the second radiator 930 may include a metal structure. The coupling structure 931 may be implemented at a segmentation portion. Coupling may be generated between ends of the segmentation portion. The second radiator 930 may be implemented with a straight metal structure continuous with the second radiator 980 of the second antenna 902.

The ground unit 940 may be connected to the second radiator 930. The ground unit 940 may be connected to a point, which faces a point where the first radiator 910 is connected, with the coupling structure 931 as the center.

The second antenna 902 may include a second feeding unit 960, a first radiator 970, a second radiator 980, and a ground unit 990.

The second radiator 980 may be directly connected to the first radiator 970 and may include a coupling structure 981. According to various embodiments of the present disclosure, the second radiator 980 may include a metal structure. The coupling structure 981 may be implemented at a segmentation portion. Coupling may be generated between ends of the segmentation portion. The second radiator 980 may be implemented with a straight metal structure continuous with the second radiator 930 of the first antenna 901.

The ground unit 990 may be connected to the second radiator 980. The ground unit 990 may be connected to a point, which faces a point where the first radiator 970 is connected, with the coupling structure 981 as the center.

The common ground unit 950 may be connected to the middle of a continuous metal structure of the second radiator 930 and the second radiator 980. The common ground unit 950 may be used in common for the first antenna 901 and the second antenna 902. Electrical lengths of the second radiators 930 and 980 may be determined according to a connection location of the common ground unit 950.

FIG. 9B is a diagram schematically illustrating an implementation of an antenna in which a plurality of coupling structures are implemented at a second radiator according to an embodiment of the present disclosure.

Referring to FIG. 9B, an antenna 900 is illustrated, where the antenna 900 may include a first antenna 901, a second antenna 902, and a common ground unit 950. The first antenna 901 may include a first feeding unit 910, a first radiator 920, a second radiator 930, and a ground unit 940. The second antenna 902 may include a second feeding unit 960, a first radiator 970, a second radiator 980, and a ground unit 990.

The second radiator 930 or 980 may be directly connected with the first radiator 920 or 970. The second radiator 930 or 980 may include a coupling structure 931 or 981. According to various embodiments of the present disclosure, the second radiator 930 or 980 may include a metal structure. The coupling structure 931 or 981 may be implemented at a segmentation portion of a metal structure. Coupling may be generated between ends of the segmentation portion. For example, in a case where an electronic device includes an outer metal cover, the coupling structures 931 and 981 may be implemented at segmentation portions of the outer metal cover, respectively. A resonance characteristic of the antenna 901 or 902 may be varied according to a change in a location of the coupling structure 931 or 981.

The ground unit 940, the common ground unit 950 or the ground unit 990 may be connected to the second radiator 930 or 980 through a contact structure. According to various embodiments of the present disclosure, the ground unit 940 of the first antenna 901 may be connected through a contact structure to a side of an electronic device including the antenna 900, and the common ground unit 950 and the ground unit 960 may be connected to a bottom end portion (or a top end portion) of the electronic device through a contact structure. An electrical length of the second radiator 930 or 980 may be varied according to a change in a connection location of the ground unit 940, the common ground unit 950 or the ground unit 990, which makes resonant frequencies variable

FIG. 9C is an input reflection coefficient graph of an antenna in which a plurality of coupling structures are implemented at a second radiator according to an embodiment of the present disclosure.

Referring to FIG. 9C, a resonant frequency of the antenna 901 of FIG. 9A is illustrated, where the resonant frequency may be generated in a low-frequency band (e.g., a band of 800 MHz to 960 MHz, graph 903 of FIG. 9C). Further, referring to FIG. 9C, a resonant frequency of the antenna 902 of FIG. 9A is illustrated, where the resonant frequency may be generated in a high-frequency band (e.g., a band of 1700 MHz to 2760 MHz, graph 904 of FIG. 9C). However, the scope and spirit of the present disclosure may not be limited thereto. A resonant frequency of the antenna 901 or 902 may be varied according to a location of the coupling structure 931 or 981 of FIG. 9A, a characteristic of dielectric, a contact location of the ground unit 940 of FIG. 9A, the common ground unit 950 of FIG. 9A, the ground unit 990 of FIG. 9A, or the like.

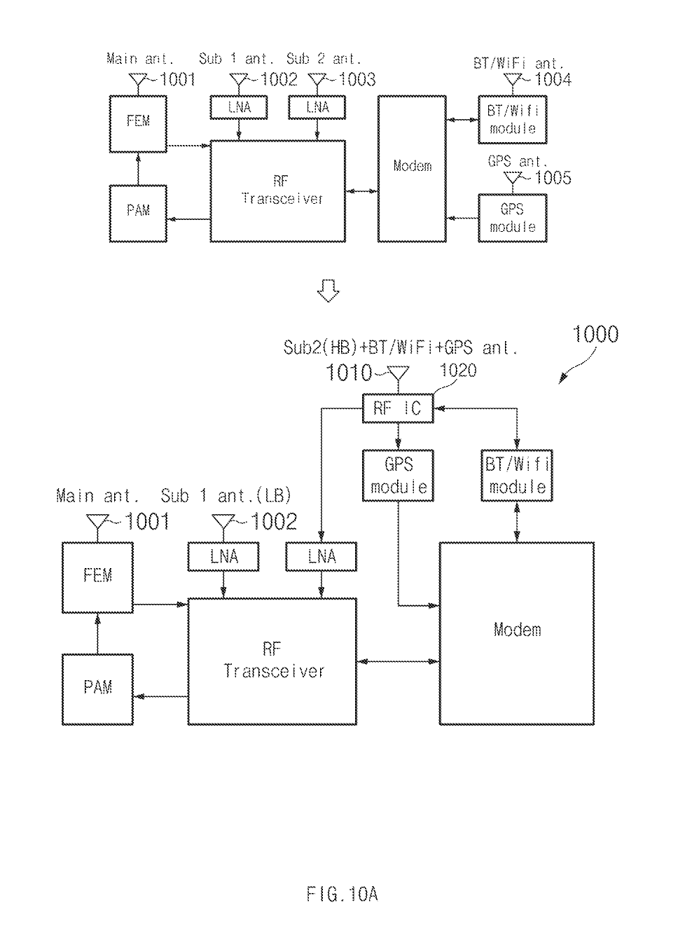

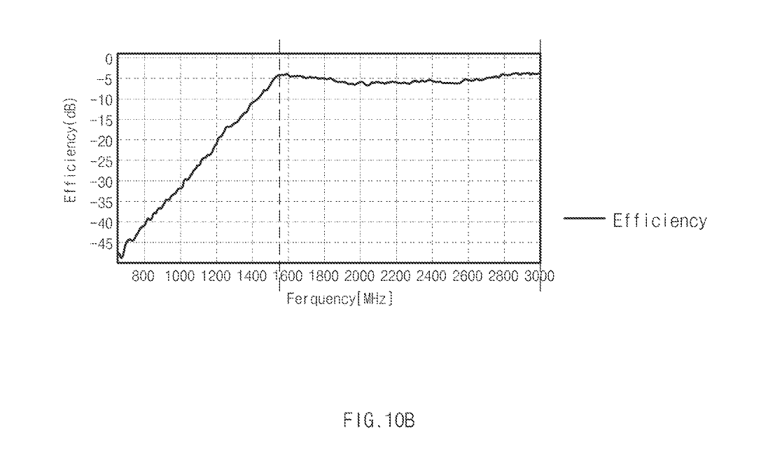

FIG. 10A is a diagram schematically illustrating a communication module including an antenna according to an embodiment of the present disclosure.

Referring to FIG. 10A, a communication module 1000 is illustrated, where the communication module 1000 may include an antenna for transmitting and receiving signals of various bands as a frequency and a required frequency bandwidth used in an electronic device increase. Referring to FIG. 10A, an embodiment of the present disclosure is exemplified as transmitting and receiving LTE communication (Main, Sub1, and Sub2), Wi-Fi/BT, and GPS signals. However, the scope and spirit of the present disclosure may not be limited thereto.

The communication module 1000 may include first to fifth antennas 1001 to 1005 and circuits or modules (e.g., FEM (front end module), PAM (power amplifier module, LNA (low noise amplifier)) for driving the first to fifth antennas 1001 to 1005, respectively.

The first to fifth antennas 1001 to 1005 may have resonant frequencies of LTE communication (Main, Sub1, and Sub2), Wi-Fi/BT, and GPS signal bands. The communication module 100 may include a single structure of antenna 1010 which includes a coupling structure for integrating the first to fifth antennas 1003 to 1005. An antenna 1010 may transmit and receive LTE communication (Sub2), Wi-Fi/BT, and GPS signals.

The antenna 1010 may be implemented in the form including a coupling structure which is the same as or similar to that of the antenna 101 illustrated in FIG. 1. In this case, the antenna 1010 may operate in three modes, that is, monopole type, loop type, and inverted-F modes, and may be implemented such that at least one of LTE communication (Sub2), Wi-Fi/BT, or GPS signals resonates in each mode.

According to various embodiments of the present disclosure, the antenna 1010 may be implemented in the form including a coupling structure and an additional ground unit which are the same as or similar to those of the antenna 201 illustrated in FIG. 2A. In this case, the antenna 1010 may be implemented such that various resonant frequencies which vary according to turn-on/turn-off of a switching unit, a shape of a coupling structure, or a location of an additional ground unit correspond to LTE communication (Sub2), Wi-Fi/BT, or GPS signals.

According to various embodiments of the present disclosure, the communication module 1000 may include a distribution unit 1020 (e.g., RF IC). The distribution unit 1020 may distribute a multi-band frequency signal, which the antenna 1010 receives, into a module (e.g., a GPS module or BT/Wi-Fi module) for processing each frequency band signal.

FIG. 10B is a communication efficiency graph of an antenna including a coupling structure according to an embodiment of the present disclosure. An antenna 1010 may cover signals of various frequency bands using a coupling structure.

Referring to FIG. 10B, the antenna 1010 of FIG. 10A may maintain a communication efficiency of 6 dB (about 25%) or more in the whole band of 3 GHz at 1.5 GHz. The antenna 1010 may transmit and receive a multi-band signal through a coupling structure in a single antenna structure and may maintain the performance of antenna efficiently within a restricted mounting space of an electronic device. The antenna 1010 may cover LTE communication (Sub2), Wi-Fi/BT, and GPS signals included in 3 GHz at 1.5 GHz.

According to various embodiments of the present disclosure, an antenna which transmits and receives a multi-band signal may include a feeding unit, a first radiator connected to the feeding unit, a second radiator coupled with the first radiator, with the first and second radiators spaced apart from each other by a specific distance, and a ground unit connected to the second radiator.

According to various embodiments of the present disclosure, the antenna may further include an additional ground unit connected to the second radiator through switching. The additional ground unit may be switched through an active element. The additional ground unit may be matched by a combination of at least one or more of capacitance, resistance, or reactance. The antenna may further include an additional radiator or an additional ground unit selectively connected to the first radiator.

According to various embodiments of the present disclosure, a coupling structure formed by the specific distance may be filled with dielectric of which permittivity is greater than 1. The first radiator may be implemented at the outermost layer of a PCB, and the second radiator may be implemented within the PCB. The first radiator may be patterned in the form of PEA at the PCB.

According to various embodiments of the present disclosure, the second radiator may include a metal structure, and the metal structure may be bent at the outside of an electronic device. The metal structure may be bent to be partitioned into a first metal portion and a second metal portion, the first radiator may be coupled with the first metal portion, and the ground unit may be connected to the second metal portion.

According to various embodiments of the present disclosure, an area of the first radiator and an area of the second radiator may face each other by a specific size or more.

According to various embodiments of the present disclosure, an antenna which transmits and receives a multi-band signal may include a feeding unit, a first radiator connected to the feeding unit, a second radiator connected to the first radiator, and ground units connected to both ends of the second radiator, respectively. The second radiator may include a segmentation portion having first and second ends spaced apart by a specific distance, and coupling may be generated between the first and second ends of the segmentation portion.

According to various embodiments of the present disclosure, an electronic device which transmits and receives a multi-band signal may include a first antenna including a first segmentation portion implemented at a radiator, the first segmentation portion having first and second ends spaced apart by a first specific distance and coupling being generated between the first and second ends of the first segmentation portion, a second antenna including a second segmentation portion implemented at a radiator, the second segmentation portion having third and fourth ends spaced apart by a second specific distance and coupling being generated between the third and fourth ends of the second segmentation portion, and a common ground unit between the first antenna and the second antenna. Each of the first antenna and the second antenna may include a feeding unit, a first radiator connected to the feeding unit, a second radiator connected to the first radiator, and a ground unit connected to the second radiator. The second radiator may include a segmentation portion having first and second ends spaced apart by a specific distance, and coupling may be generated between the first and second ends of the segmentation portion. The electronic device may further include an additional radiator or an additional ground unit connected to the first radiator of the first antenna.

According to various embodiments of the present disclosure, an electronic device may include includes an antenna for transmitting and receiving a multi-band signal, and the antenna may include a feeding unit, a first radiator connected to the feeding unit, a second radiator coupled with the first radiator, with the first and second radiators spaced apart from each other by a specific distance, a ground unit connected to the second radiator, and an additional ground unit connected to the second radiator through switching.

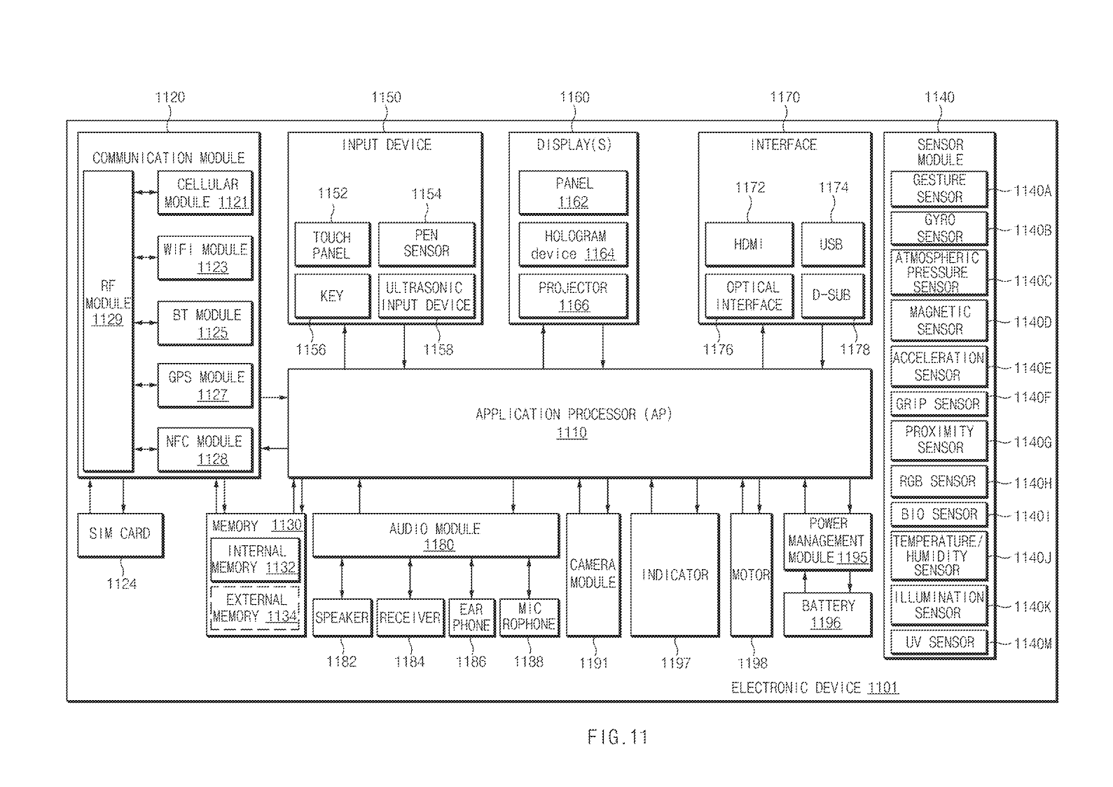

FIG. 11 is a block diagram illustrating an electronic device according to an embodiment of the present disclosure.

Referring to FIG. 11, an electronic device 1101 is illustrated, where the electronic device 1101 may include one or more application processors (AP) 1110, a communication module 1120, a subscriber identification module (SIM) card 1124, a memory 1130, a sensor module 1140, an input device 1150, a display 1160, an interface 1170, an audio module 1180, a camera module 1191, a power management module 1195, a battery 1196, an indicator 1197, and a motor 1198.

The AP 1110 may drive an operating system (OS) or an application to control a plurality of hardware or software components connected to the AP 1110 and may process and compute a variety of data including multimedia data. The AP 1110 may be implemented with a system on chip (SoC), for example. According to an embodiment of the present disclosure, the AP 1110 may further include a graphics processing unit (GPU) (not illustrated).

The communication module 1120 (e.g., the communication module 1000 of FIG. 10B) may transmit and receive data when there are conveyed communications between other electronic devices connected with the electronic device 1101 through a network. According to an embodiment of the present disclosure, the communication module 1120 may include a cellular module 1121, a Wi-Fi module 1123, a BT module 1125, a GPS module 1127, a near field communication (NFC) module 1128, and a radio frequency (RF) module 1129.

The cellular module 1121 may provide voice communication, video communication, a character service, an Internet service or the like through a communication network (e.g., an LTE, an LTE-advanced (LTE-A), a code division multiple access (CDMA), a wireless CDMA (WCDMA), a universal mobile telecommunications system (UMTS), a wireless broadband (WiBro), a global system for mobile communications (GSM), or the like). Also, the cellular module 1121 may perform discrimination and authentication of an electronic device within a communication network using a SIM (e.g., the SIM card 1124), for example. According to an embodiment of the present disclosure, the cellular module 1121 may perform at least a portion of functions that the AP 1110 provides. For example, the cellular module 1121 may perform at least a portion of a multimedia control function.

According to an embodiment of the present disclosure, the cellular module 1121 may include a communication processor (CP). Also, the cellular module 1121 may be implemented with, for example, a SoC. Although components such as the cellular module 1121 (e.g., a CP), the memory 1130, the power management module 1195, and the like are illustrated as being components independent of the AP 1110, the AP 1110 may be implemented to include at least a portion (e.g., a cellular module 1121) of the above components.

According to an embodiment of the present disclosure, the AP 1110 or the cellular module 1121 (e.g., a CP) may load and process an instruction or data received from nonvolatile memories respectively connected thereto or from at least one of other elements at the nonvolatile memory. Also, the AP 1110 or the cellular module 1121 may store data received from at least one of other elements or generated by at least one of other elements at a nonvolatile memory.

Each of the Wi-Fi module 1123, the BT module 1125, the GPS module 1127, and the NFC module 1128 may include a processor for processing data exchanged through a corresponding module, for example. Referring to FIG. 11, an embodiment of the present disclosure is exemplified as the cellular module 1121, the Wi-Fi module 1123, the BT module 1125, the GPS module 1127, and the NFC module 1128 are separate blocks, respectively. According to an embodiment of the present disclosure, at least a portion (e.g., two or more components) of the cellular module 1121, the Wi-Fi module 1123, the BT module 1125, the GPS module 1127, and the NFC module 1128 may be included within one Integrated Circuit (IC) or an IC package. For example, at least a portion (e.g., a CP corresponding to the cellular module 1121 and a Wi-Fi processor corresponding to the Wi-Fi module 1123) of CPs corresponding to the cellular module 1121, the Wi-Fi module 1123, the BT module 1125, the GPS module 1127, and the NFC module 1128 may be implemented with one SoC.

The RF module 1129 may transmit and receive data, for example, an RF signal. Although not illustrated, the RF module 1129 may include a transceiver, a power amplifier module (PAM), a frequency filter, or low noise amplifier (LNA). Also, the RF module 1129 may further include the following part for transmitting and receiving an electromagnetic wave in a space in wireless communication: a conductor or a conducting wire. Referring to FIG. 11, an embodiment of the present disclosure is exemplified as the cellular module 1121, the Wi-Fi module 1123, the BT module 1125, the GPS module 1127, and the NFC module 1128 are implemented to share one RF module 1129. According to an embodiment of the present disclosure, at least one of the cellular module 1121, the Wi-Fi module 1123, the BT module 1125, the GPS module 1127, or the NFC module 1128 may transmit and receive an RF signal through a separate RF module.

The SIM card 1124 may be a card that includes a SIM and may be inserted to a slot formed at a specific position of the electronic device. The SIM card 1124 may include unique identify information (e.g., integrated circuit card identifier (ICCID)) or subscriber information (e.g., integrated mobile subscriber identity (IMSI)).

The memory 1130 may include an internal memory 1132 or an external memory 1134. For example, the internal memory 1132 may include at least one of a volatile memory (e.g., a dynamic random access memory (DRAM), a static RAM (SRAM), or a synchronous DRAM (SDRAM)) and a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a not and (NAND) flash memory, or a not or (NOR) flash memory).

According to an embodiment of the present disclosure, the internal memory 1132 may be a solid state drive (SSD). The external memory 1134 may include a flash drive, for example, compact flash (CF), secure digital (SD), micro-SD, mini-SD, extreme digital (xD) or a memory stick. The external memory 1134 may be functionally connected to the electronic device 1101 through various interfaces. According to an embodiment of the present disclosure, the electronic device 1101 may further include a storage device (or a storage medium), such as a hard drive.

The sensor module 1140 may measure a physical quantity or may detect an operation state of the electronic device 1101. The sensor module 1140 may convert the measured or detected information to an electric signal. The sensor module 1140 may include at least one of a gesture sensor 1140A, a gyro sensor 1140B, a (atmospheric) pressure sensor 1140C, a magnetic sensor 1140D, an acceleration sensor 1140E, a grip sensor 1140F, a proximity sensor 1140G, a color sensor 1140H (e.g., red, green, blue (RGB) sensor), a biometric sensor 1140I, a temperature/humidity sensor 1140J, an illuminance/illumination sensor 1140K, or an ultraviolet (UV) sensor 1140M. Although not illustrated, additionally or generally, the sensor module 1140 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 1140 may further include a control circuit for controlling at least one or more sensors included therein.

The input device 1150 may include a touch panel 1152, a (digital) pen sensor 1154, a key 1156, or an ultrasonic input device 1158. The touch panel 1152 may recognize a touch input using at least one of capacitive, resistive, infrared and ultrasonic detecting methods. Also, the touch panel 1152 may further include a control circuit. In a case of using the capacitive detecting method, a physical contact recognition or proximity recognition may be allowed. The touch panel 1152 may further include a tactile layer. In this case, the touch panel 1152 may provide a tactile reaction to a user.

The (digital) pen sensor 1154 may be implemented in a similar or same manner as the method of receiving a touch input of a user or may be implemented using an additional sheet for recognition. The key 1156 may include, for example, a physical button, an optical key, a keypad, and the like. The ultrasonic input device 1158, which is an input device for generating an ultrasonic signal, may enable the electronic device 1101 to sense/detect a sound wave through a microphone (e.g., a microphone 1188) so as to identify data, wherein the ultrasonic input device 1158 is capable of wireless recognition. According to an embodiment the present disclosure, the electronic device 1101 may use the communication module 1120 so as to receive a user input from an external device (e.g., a computer or server) connected to the communication module 1120.

The display 1160 may include a panel 1162, a hologram device 1164, or a projector 1166. The panel 1162 may be, for example, a liquid crystal display (LCD), an active matrix organic light-emitting diode (AM-OLED), or the like. The panel 1162 may be, for example, flexible, transparent or wearable. The panel 1162 and the touch panel 1152 may be integrated into a single module. The hologram device 1164 may display a stereoscopic image in a space using a light interference phenomenon. The projector 1166 may project light onto a screen so as to display an image. The screen may be arranged in the inside or the outside of the electronic device 1101. According to an embodiment of the present disclosure, the display 1160 may further include a control circuit for controlling the panel 1162, the hologram device 1164, or the projector 1166.

The interface 1170 may include, for example, a high-definition multimedia interface (HDMI) 1172, a universal serial bus (USB) 1174, an optical interface 1176, or a D-subminiature (D-sub) 1178. The interface 1170 may be included, for example, in a communication interface 760 illustrated in FIGS. 7A and 7B. Additionally or generally, the interface 1170 may include, for example, a mobile high definition link (MHL) interface, a SD card/multi-media card (MMC) interface, or an infrared data association (IrDA) standard interface.

The audio module 1180 may convert a sound and an electric signal in dual directions. The audio module 1180 may process, for example, sound information that is input or output through a speaker 1182, a receiver 1184, an earphone 1186, or the microphone 1188.

According to an embodiment of the present disclosure, the camera module 1191 for shooting a still image or a video may include at least one image sensor (e.g., a front sensor or a rear sensor), a lens (not illustrated), an image signal processor (ISP, not illustrated), or a flash (e.g., an LED or a xenon lamp, not illustrated).

The power management module 1195 may manage power of the electronic device 1101. Although not illustrated, a power management integrated circuit (PMIC) a charger IC, or a battery or fuel gauge may be included in the power management module 1195.

The PMIC may be mounted on an integrated circuit or a SoC semiconductor. A charging method may be classified into a wired charging method and a wireless charging method. The charger IC may charge a battery, and may prevent an overvoltage or an overcurrent from being introduced from a charger. According to an embodiment of the present disclosure, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier, and the like.

The battery gauge may measure, for example, a remaining capacity of the battery 1196 and a voltage, current or temperature thereof while the battery is charged. The battery 1196 may store or generate electricity, and may supply power to the electronic device 1101 using the stored or generated electricity. The battery 1196 may include, for example, a rechargeable battery or a solar battery.

The indicator 1197 may display a specific state of the electronic device 1101 or a portion thereof (e.g., the AP 1110), such as a booting state, a message state, a charging state, and the like. The motor 1198 may convert an electrical signal into a mechanical vibration. Although not illustrated, a processing device (e.g., a GPU) for supporting a mobile TV may be included in the electronic device 1101. The processing device for supporting a mobile TV may process media data according to the standards of digital multimedia broadcasting (DMB), digital video broadcasting (DVB) or MediaFlo™.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit,” “logic,” “logical block,” “component” and “circuit.” The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a portion of an apparatus (e.g., modules or functions thereof) or a method (e.g., operations) according to various embodiments of the present disclosure may be, for example, implemented by instructions stored in a computer-readable storage media in the form of a programmable module. The instruction, when executed by one or more processors (e.g., a processor 1110), may cause the one or more processors to perform a function corresponding to the instruction. The computer-readable storage media, for example, may be the memory 1130. At least a portion of the programming module may be implemented (e.g., executed), for example, by the processor 1110. At least a portion of the programming module may include, for example, modules, programs, routines, sets of instructions, or processes, or the like for performing one or more functions.

A computer-readable recording medium may include hardware, which is configured to store and execute a program instruction (e.g., a programming module), such as a hard disk, a magnetic media such as a floppy disk and a magnetic tape, an optical media such as compact disc ROM (CD-ROM) and a DVD, a magneto-optical media such as a floptical disk, and hardware devices such as ROM, RAM, and a flash memory. Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

A module or a programming module according to an embodiment of the present disclosure may include at least one of the above elements, or a portion of the above elements may be omitted, or additional other elements may be further included. Operations performed by a module, a program module, or other elements according to an embodiment of the present disclosure may be executed sequentially, in parallel, repeatedly, or in a heuristic method. Also, a portion of operations may be executed in different sequences, omitted, or other operations may be added.

According to various embodiments of the present disclosure, it may be possible to transmit and receive a multi-band frequency signal efficiently through a single structure including a coupling structure.

According to various embodiments of the present disclosure, a multi-band antenna may be simplified by implementing a ground unit connected through a coupling structure or a switch, thereby making it possible to maintain the performance of an antenna mounted in a restricted space efficiently.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An antenna for transmitting and receiving a multi-band signal, the antenna comprising:
a feeding unit;
a first radiator connected to the feeding unit;
a second radiator coupled with the first radiator, such that the first radiator and the second radiator are spaced apart from each other by a specific distance; and
a ground unit connected to the second radiator.

2. The antenna of claim 1, further comprising:
an additional ground unit connected to the second radiator through switching.

3. The antenna of claim 2, wherein the additional ground unit is switched through an active element.

4. The antenna of claim 2, wherein the additional ground unit is matched by a combination of at least one or more of capacitance, resistance, and reactance.

5. The antenna of claim 2, further comprising:
one of an additional radiator and a second additional ground unit selectively connected to the first radiator.

6. The antenna of claim 1, wherein a coupling structure formed by the specific distance is filled with a dielectric of which permittivity is greater than 1.

7. The antenna of claim 1,
wherein the first radiator is implemented at an outermost layer of a printed circuit board (PCB), and
wherein the second radiator is implemented within the PCB.

8. The antenna of claim 7, wherein the first radiator is patterned in a form of a PCB embedded antenna (PEA) at the PCB.

9. The antenna of claim 1,
wherein the second radiator comprises a metal structure, and
wherein the metal structure is bent at an outside of an electronic device.

10. The antenna of claim 9,
wherein the metal structure is bent to be partitioned into a first metal portion and a second metal portion,
wherein the first radiator is coupled with the first metal portion, and
wherein the ground unit is connected to the second metal portion.

11. The antenna of claim 1, wherein an area of the first radiator and an area of the second radiator face each other to form a specific size or more.

12. The antenna of claim 1, wherein an electrical length of the second radiator is controlled by switching units based on contents of a control table.

13. An antenna for transmitting and receiving a multi-band signal, the antenna comprises:
a feeding unit;
a first radiator connected to the feeding unit;
a second radiator connected to the first radiator;
a first ground unit connected to one end of the second radiator; and
a second ground unit connected to another end of the second radiator,
wherein the second radiator comprises a segmentation portion having first and second ends spaced apart by a specific distance, and
wherein a coupling is formed between the first and second ends of the segmentation portion.

14. An electronic device for transmitting and receiving a multi-band signal, the electronic device comprising:
a first antenna including a first segmentation portion implemented at a radiator, the first segmentation portion having first and second ends spaced apart by a first specific distance and a coupling formed between the first and second ends of the first segmentation portion;
a second antenna including a second segmentation portion implemented at another radiator, the second segmentation portion having third and fourth ends spaced apart by a second specific distance and a coupling formed between the third and fourth ends of the second segmentation portion; and
a common ground unit disposed between the first antenna and the second antenna.

15. The electronic device of claim 14,
wherein each of the first antenna and the second antenna comprises:
a feeding unit;
a first radiator connected to the feeding unit;
a second radiator connected to the first radiator; and
a ground unit connected to the second radiator,
wherein the second radiator comprises a segmentation portion having first and second ends spaced apart by a specific distance, and
wherein a coupling is formed between the first and second ends of the segmentation portion.

16. The electronic device of claim 15, further comprising:
one of an additional radiator and an additional ground unit connected to the first radiator of the first antenna.

17. An electronic device including:
an antenna configured to transmit and receive a multi-band signal, wherein the antenna comprises:
a feeding unit,
a first radiator connected to the feeding unit,
a second radiator coupled with the first radiator, such that the first radiator and the second radiator are spaced apart from each other by a specific distance,
a ground unit connected to the second radiator, and
an additional ground unit connected to the second radiator through switching.
